(19) United States
(12) Patent Application Publication
(10) Pub. No.: US 2012/0260939 A1
(43) Pub. Date: Oct. 18, 2012

(54) Windscreen Wiper Blade and Device for Wiping and Washing a Glazed Surface of a Motor Vehicle and Corresponding Wiping and Washing Method

(75) Inventors: Gerard Jeuffe, Bazemont (FR); Brahim Hamza, Guilherand-Granges (FR); Jean-Michel Issartel, Romans Sur Isere (FR); Akim Driss Bouguerra, Villeurbanne (FR); Rodolphe Emaille, La Cote St Andre (FR)

(73) Assignees: MGI COUTIER, Champfromier (FR); PEUGEOT CITROEN AUTOMOBILES S.A., Velizy Villacoublay (FR)

(21) Appl. No.: 13/511,226

(22) PCT Filed: Nov. 22, 2010
(86) PCT No.: PCT/FR2010/052484

§ 371 Date: Jul. 9, 2012

(30) Foreign Application Priority Data
Nov. 23, 2009 (FR) 0958273

(51) Int. Cl. B60S 1/52; B08B 1/04

(52) U.S. Cl. 134/6; 15/250.04

(57) ABSTRACT

The invention relates to a windscreen-wiper blade (1) of a motor vehicle which comprises: an elongate flexible strip (6); a conduit outlet (23) arranged such as to be able to spray a jet of liquid in substantially the longitudinal direction of the strip (6); characterised in that the conduit outlet (23) is offset on the side of the flexible strip (6) relative to the longitudinal médian plane of the flexible strip (6).

### CROSS-REFERENCE TO RELATED APPLICATIONS

This application is the US National Stage under 36 U.S.C. §371 of International App. No. PCT/FR2010/152484 filed Nov. 22, 2010, and which claims priority to French App. No. 0958273 filed Nov. 23, 2009.

### BACKGROUND

The present invention relates to a windscreen wiper blade that comprises at least one nozzle mounted parallel to a lip of the wiper blade for spreading a thin stream of washer fluid on the lip of the wiper blade.

A traditional windscreen wiper blade comprises, in general, an arm driven in alternating rotation by a reversible drive motor. This arm carries a flexible wiper blade made of rubber or similar material, which is applied against the surface of the windscreen by a spring loaded spreader mounted between the blade and the arm. The wiper blade is deformable according to the angular position of the arm and the curvature of the windscreen in the area against which the wiper blade rests.

In a variant, the blade of the wiper can be directly connected to the oscillating arm by means of a flexible spine extending over the whole length of the wiper blade and comprising an integral metallic stiffening frame or similar, joined to a flexible lip applied on the glass surface.

In still other solutions, the arm is not driven by an oscillating movement around an axis but by a linear displacement movement facing the glass surface to be wiped, whereby the wiper blade rests against this surface employing in principle the same means as the oscillating version.

In all cases, the arm exerts on the flexible wiper blade of the wiper a force substantially normal to the windscreen due to the deformation of the spring loaded spreader or to the relative flexibility of the spine, whereby this effort varies as a function of the curvature of the glass surface in contact with the wiper blade.

In the prior art, cleaning of the windscreen or the rear window normally occurs by spraying washer fluid on the glass surface by means of nozzles installed on the hood or on the cowl grille of the vehicle. These nozzles, installed at a distance from the glass surface to be cleaned, require delicate adjustment in order to obtain an effective spray. These so-called fluidic nozzles project washer fluid in the form of spray over the entire area of the glass surface. This washing operation uses a significant volume of fluid and, for a few seconds, obscures the driver's visibility. In addition, during night driving, light beams projecting from the headlights of oncoming vehicles cause fragmentation of the light beams on the windscreen, blinding the driver for a few moments. Consequently, this washing and wiping operation could turn out to be very dangerous because of the potential risks that it can create. In addition, the projection of the washer fluid jet is variable depending on the speed of the vehicle; for instance, at high speed the washer fluid jet is projected only on the lower portion of the glass surface which results of course in insufficient cleaning of the glass surface. It is clear that the wash system is specifically designed for each type of vehicle, which entails significant development costs.

WO01/51323 describes a wiper comprising a wiper blade and additional longitudinal conduits joined to the spine of the wiper blade. These conduits form spraying ramps intended to project a washer fluid in the form of spray on the glass surface in front of the lip of the wiper blade during the sweeping movement.

DE 1755762 describes a washer fluid projection device in connection with a wiping mechanism for a windscreen. The mechanism comprises a mobile mounted windscreen wiper blade, sweeping the glass surface, and comprises the traditional longitudinal support assembly and a wiper blade.

The projection device consists of an arm on which the wiper is mounted and is adapted to the wiper so that the washer fluid is projected in the form of a jet on the glass surface in front of the lip of the wiper blade relative to its sweeping movement.

FR291 671 6 proposes an arrangement for a washer fluid projection device. The washer fluid projection nozzle is placed at the end and on the outside of the wiper blade, precisely in the axis of its median part in order to spray a fluid jet alternatively on the glass surface in front of the wiper lip, during its sweeping movement.

In particular, in this arrangement, the washer fluid projection nozzle located at the end of the windscreen wiper blade is carried by the arm on which the windscreen wiper blade is mounted. In this way, the axes of wiper blade and nozzle are aligned resulting in washer fluid being projected only on the glass surface in front of the wiper blade, when the latter performs the washing and wiping movements of the glass surface.

The problem with this device resides in the fact that the washer fluid is wiped off instantly during the movement of the windscreen wiper blade. Because of the speed, the washer fluid cannot spread over the whole length of the wiper blade, even if the centrifugal force tends to direct it towards the upper extremity of the lip of the wiper blade. In these conditions, washing and wiping of the glass surface are not properly done.

### BRIEF SUMMARY

In order to remedy these problems, we have designed a windscreen wiper blade and a method for washing and wiping which cleans the whole area traveled by the windscreen wiper blade, by spreading the washer fluid in advance over the whole length of the lip of the wiper blade, when the lip of the windscreen wiper blade is in a stop phase prior to returning.

For cleaning of a glass surface, EP 0860336 proposes a wiper blade connected in traditional manner to a mobile windscreen wiper arm. The wiper blade comprises, in its lower part, the lip and, in its upper part, a means for mounting to a frame, and a channel extending longitudinally in the interior of the wiper blade in order to carry washer fluid to an end piece in each of the extremities of the wiper blade. These end pieces have a nipple for supplying fluid introduced in the channel of the wiper blade. The supply nipple is positioned in the median axis of the end piece comprising conduits in the form of an inverted V. The exit nozzles are directed in such a manner that they deliver a jet of washer fluid, in the form of spray at a variable distance from the wiper blade depending on the angle of the V, to the glass surface on both sides of the wiper blade.

All of the prior art documents disclose washing and wiping systems systematically projecting washer fluid on a portion of the glass surface, so that precise adjustment and positioning of the nozzle and conduit relative to the windscreen wiper blade is not required.

The goal of the invention is to provide a windscreen wiper blade and a washing and wiping device that eliminates these inconveniences, in particular by eliminating tedious adjustments of the nozzles on the hood and on the cowl grille, while ensuring a good distribution of the of the washer fluid on the edge of the wiper blade which is in contact with the glass surface. To this end, the washer fluid supply conduit must be positioned strictly in relation to the lip of the windscreen wiper blade in order to project washer fluid uniformly in the longitudinal concavity of the lip of the wiper blade of the windscreen wiper. Because of this, during the washing and wiping operation of the glass surface, the washer fluid is trapped only under the lip of the wiper blade of the windscreen wiper and total visibility is guaranteed to the driver.

To this end, the windscreen wiper blade of an automotive vehicle, comprises a flexible elongated wiper blade, a conduit exit arranged so that it can project a fluid jet in a longitudinal direction of the wiper blade, and wherein the exit of the conduit is offset on the side of the flexible wiper blade relative to the median longitudinal plane of the flexible wiper blade and wherein the flexible wiper blade supports a conduit equipped with a nozzle which is offset laterally relative to the longitudinal median axis of the wiper blade at a distance such that when the windscreen wiper blade is in an inactive position on the glass surface, the orifice of the nozzle is positioned in the direction of the concave part of the lip of the wiper blade so that the washer fluid jet spreads over the majority of the length of the lip of the wiper blade.

According to other advantageous characteristics of the wiper assembly:
The conduit exit is located in one of the extremities of the wiper blade.
The conduit exit is arranged along the wiper blade.
The exit of the conduit comprises a nozzle.
The axis of the nozzle is arranged parallel to the lip of the wiper blade in order to direct the washer fluid to the concavity of the lip of the wiper blade when the wiper blade is in a stop position, before returning, so that the washer fluid flow is optimized in the concavity of the lip of the wiper blade.
The axis of the nozzle is oriented in the direction of the lip of the wiper blade in order to direct the washer fluid to the lip of the wiper blade when the latter is in its stop position, before returning for wiping of the glass surface, which allows for an even distribution of the washer fluid on the glass surface.
The nozzle conduit is arranged in a device suitable for holding it in a determined position relative to the lip of the wiper blade.
The holding device is comprised of an elastic ring, a support part of which is clipped in an appropriate manner on the extremity of the windscreen wiper blade, which allows for effective and inexpensive maintenance.
The nozzle conduit comprises at its extremity, opposite the nozzle, a means for connecting a line intended to transport washer fluid from the storage reservoir in direction of the conduit and the nozzle.
The exit conduit delivers a constant flow, which provides simplicity of assembly, eliminating adjustments.
The invention also relates to a windscreen wiper arm carrying a wiper blade with the conduit exit located in the extremity of the wiper blade which is situated on the side of the fixing the arm.
The wiper assembly also has a washing and wiping device comprising at least a windscreen wiper blade for a glass surface or an arm for a wiper blade and an automotive vehicle comprising at least one washing and wiping device for a glass surface.

A method for washing and wiping a glass surface is also disclosed which comprises at least a windscreen wiper blade comprising a flexible elongated wiper blade resting against the glass surface to be swept, whereby the wiper blade supports a conduit exit which is offset on the side of the wiper blade at a distance such that when the windscreen wiper blade is at an end of travel position on the glass surface, the exit of the conduit is positioned facing the concave part of the lip of the wiper blade, the method comprising:
Prior to starting the wiper blade, a step in which a jet of washer fluid flows over a major portion of the length of the concave part or the lip of the wiper blade, through the conduit exit,
When the movement of the wiper is started, a step in which the lip returns and during which the washer fluid spreads over the portion of the lip in contact with the glass surface in order to perform the washing of the glass zone to be cleaned.
   One or more of the preceding characteristics can be added to the method of washing and wiping:
Adjusting the washer jet to flow over the length of the lip of the washer blade over at least three quarters of its length.
Distributing the washer fluid from the nozzle arranged in a first extremity of the lip of the wiper blade, up to a second extremity of the lip of the wiper blade, under the influence of centrifugal force when the wiper blade is moving; during this movement the second extremity describes a larger radius than the first extremity.
When the wiper blade stops in the approximately vertical position at the end of its travel over the zone to be wiped, and prior to returning, spreading a jet of washer fluid over the length of the lip of the wiper blade by the nozzle disposed in the extremity of the wiper blade which describes the largest radius of the two extremities.

The wiper assembly also has as a goal a method for washing and wiping comprising at least one windscreen wiper blade for a glass surface.

### BRIEF DESCRIPTION OF THE DRAWINGS

Other characteristics of a windscreen wiper blade constructed according to the invention, will become clear through the following description of several embodiments given as non-limiting illustrations with reference to the attached drawings in which:

FIG. 1 is a perspective view of a washer and wiper assembly for a glass surface according to the invention, in an inactive position.

FIG. 2 is a cross-section in profile along line A-A of FIG. 4 of a windscreen wiper blade equipped with a support and a nozzle according to the invention whereby the lip of the wiper blade is shown in a neutral position in the median longitudinal plane.

FIG. 3 is a view in profile of a windscreen wiper blade equipped with a support and a nozzle in which the wiper blade is shown in cross-section taken along line A-A of FIG. 5, and in an inactive position on a glass surface.

FIG. 4 is a view in profile of a windscreen wiper blade equipped with a support and a nozzle of which the wiper blade is shown in cross-section taken along line A-A of FIG. 5 according to a sweeping position of the glass surface.

FIG. 5 is a perspective view of the extremity of a windscreen wiper blade equipped with an end piece receiving the conduit equipped with the nozzle according to the invention.

FIG. 6 is a cross-sectional view taken along line B-B of FIG. 2 of the extremity of the windscreen wiper blade equipped with a end piece showing the conduit equipped with a nozzle according to the invention.

FIG. 7 is a view in cross-section taken along line C-C of FIG. 3.

### DETAILED DESCRIPTION

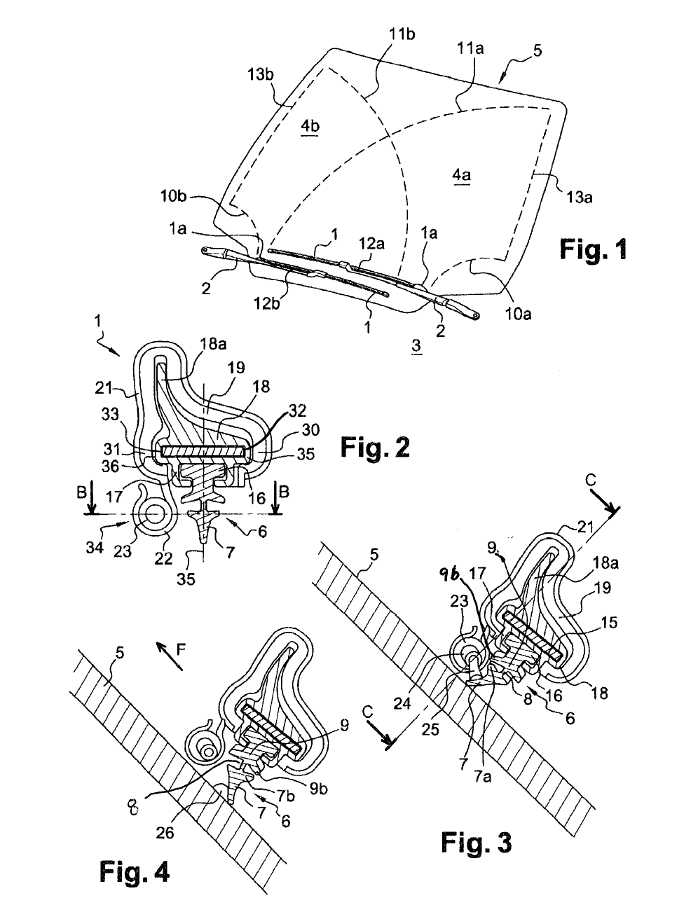

FIG. 1 shows a perspective view of an assembly for washing and wiping a glass surface comprising a pair of windscreen wiper blades, in an inactive position. In this view the windscreen wiper blades 1 are mounted in traditional manner on an arm 2 by means of an articulation arranged in the middle part of the windscreen wiper blade 1. At the other end, the arms 2 are mounted on motorized means connected to the vehicle body 3 so that the wiper blades travel simultaneously over the areas 4a-4b of the glass surface to be wiped such as for instance a windscreen 5. In FIG. 1, the windscreen wiper blades 1 are shown in their inactive position, in other words in a position parallel to each other and approximately parallel to the lower edge of the windscreen. The windscreen wiper blades shown in FIG. 1 are called antagonists because they move in opposite directions relative to each other. The windscreen wiper blades can also move parallel relative to each other, or only one glass wiper can be arranged to wipe a zone of the windscreen, or the rear window, or the headlights. All these wiping means variants do not affect in any way the operating principle of the windscreen wiper blade, which will be described below. The windscreen wiper blades 1 shown in the figure comprise in their lower extremities, in a suitable end piece 1a, and a conduit equipped with a nozzle positioned in parallel to the wiper blade of the windscreen wiper blade. The conduit is placed on the side of the area to be wiped so that a jet of washer fluid can be delivered to the lip of the wiper blade of the windscreen wiper blade. The nozzles placed in the lower part of the wiper blade define, relative to the axis of rotation of the arm, a small radius 10a-10b when sweeping the area to be wiped, while the upper extremity of the wiper blades define a large radius 11a-11b. The travel of the wiper blades, between positions 12a-12b parallel to the internal edge of the windscreen and positions 13a-13b approximately parallel to the lateral edge of the windscreen, defines the areas 4a-4b to be wiped. A nozzle could also be mounted in the upper extremity of the windscreen wiper, facing the nozzle located in the lower extremity, in other words located on the side of the area to be wiped when the blade is in its maximum position or approximately parallel to the lateral edge of the windscreen.

FIG. 2 is the profile view of cross-section A-A of FIG. 5 of a windscreen wiper blade equipped with a support and a nozzle whereby the lip of the wiper blade is shown in a neutral position in the median longitudinal plane.

The windscreen wiper blade 1 illustrated in the FIG. 5 comprises essentially a flexible, elongated wiper blade 6, made of rubber or similar material suitable to be used for cleaning a glass surface 5 against which rests lip 7 of the wiper blade 6. This glass surface consists in particular of the surface of the front windscreen or of the rear window of an automotive vehicle.

Wiper blade 6 has in its upper part a tenon 16 which is inserted in a mortise 17 made in the lower part of frame 18. Tenon 16 of wiper blade 6 slides freely in mortise 17 of frame 18. This frame 18 has a wall which becomes progressively thinner in a vertical plane to form a deflector 18a. Frame 18 comprises articulated connection means (not shown) in arm 2. In order to improve the overall appearance of the windscreen wiper blade 1, embellishing caps 19 are mounted on each of the extremities of the windscreen wiper blade. Caps 19 cover the extremities of frame 18 and partially cover wiper blade 6 in order to reinforce the perceived quality. The axis of conduit 23 is positioned parallel to the axis of wiper blade 6, at a distance from the wiper blade, so that the nozzle 24 is facing the concavity of lip 7 of wiper blade 6 when the wiper blade is in the inactive position (visible on FIG. 3), in other words in rest position when it is approximately parallel to the lower edge of the glass surface 5 such as for instance the windscreen of an automotive vehicle, as we will see further down with the help of FIG. 3. The caps 19 have the general form of the profile of frame 18 on which they fit in each extremity. In particular, in their lower part, they have two C shaped legs 30-31 facing each other and used to guide them and to enclose the sliding part of frame 18, while protuberances 32-33 are arranged in the hollows of the C's to exercise clamping pressure on the flanks 35-36 of frame 9 during the sliding assembly of caps 19.

In this version of wiper blade 6, cap 19 receives a profiled support 21 which is extended in its lower part by a means 22 for holding an assembly 34 of conduit and nozzle, on the side of wiper blade 6 where the sweeping movement of the windscreen wiper blade 6 takes place. The conduit and nozzle assembly 34 is incorporated with precise orientation suitable for the position of lip 7 of wiper blade 6. This assembly 34 allows for delivering of a washer fluid jet to lip 7 of wiper blade 6 of the windscreen wiper blade 1. Because of the precise guiding of cap 19 when it is mounted on the windscreen wiper blade 1, the conduit and nozzle assembly 34 is precisely positioned in an offset manner relative to lip 7 of wiper blade 6.

FIG. 2 shows the windscreen wiper blade 1 comprising wiper blade 6, in a neutral position, in other words in a position whereby the windscreen wiper blade 1 is not resting against the glass surface 5 or when it is not mounted on the arm and is not subject to any stress or load, in particular lip 7 of wiper blade 6 is positioned in the median longitudinal plane of the wiper blade 6, symbolized by axis 35.

FIG. 3 is a view in profile of a cross-section of a windscreen wiper blade according to the invention shown in the inactive position when positioned on the glass surface 5. This glass surface 5 usually has a more or less pronounced curvature, according space traveled by the windscreen wiper blade 1 during its travel while in contact with the glass surface, against which the windscreen wiper blade perfectly complies. In the inactive position, the lip 7 of wiper blade 6, resting horizontally in a longitudinal direction against the windscreen 5 which is mounted in the car body in an inclined position, forms an upward oriented concavity over its length. In this configuration, heel 7a of lip 7 comes in contact with shoulder 9a of base 9 of wiper blade 6. The assembly 34, comprised of a conduit 23 and a nozzle 24, is located, taking into account the configuration, approximately above the concavity of lip 7 of wiper blade 6. In particular, conduit 23 can be equipped in its extremity with a ball joint nozzle 24 which allows for the delivery in more precise manner of a washer fluid jet 25 to lip 7 of wiper blade 6 of the windscreen wiper blade 1. This fluid jet 25 is adjusted so that it is approximately cylindrical ensuring that the washer fluid is distributed regularly in the concavity of lip 7 of wiper blade 6 over the major portion of its length. It is evident from the figure, that wiper blade 6 is in a position approximately parallel to lower edge of the glass surface and favors the regular flow of washer fluid along the lip 7 of wiper blade 6. The fact that the washer fluid is poured on the wiper blade ensures that it is wetted, especially in the contact area between the extremity of the lip and the glass surface, because often lip 7 of wiper blade 6 sticks to the surface, this wetting alleviates the sticking and the friction of lip 7 of wiper blade 6 on the glass surface 5, which is beneficial and advantageously increases the longevity of wiper blade 6. During the inversion of the wiping movement, lip 7 of wiper blade 6 is subject to a rotation around hinge 8. When the wiping starts, lip 7 of wiper blade 6 will undergo a rotation and heel 7a of lip 7 will come in contact with shoulder 9b of frame 9 of wiper blade 6 as shown in FIG. 4.

FIG. 4 is a view in profile of a windscreen wiper blade sweeping glass surface 5 in the direction of arrow F. In this position, the windscreen wiper blade 1 performs the washing and wiping of glass surface 5. In this position, lip 7 of wiper blade 6 has pivoted around articulation hinge 8 and the heel 7b of lip 7 comes in contact with shoulder 9b of frame 9 of wiper blade 1. In this arrangement, the washer fluid 26 is interposed in the angle formed between the extremity of lip 7 of wiper blade 6 and the glass surface 5, over the whole length of the wiper blade 6. It is evident that in this position washing of the glass surface is optimal, because only the necessary and sufficient washer fluid is supplied to the wiper blade 6 in order to obtain effective cleaning of the area swept by the windscreen wiper blade 1.

FIG. 5 is a perspective view of the extremity of a windscreen wiper blade equipped with an end piece receiving the conduit 23 equipped with a nozzle 24. In this perspective view of the extremity of the windscreen wiper blade 1, frame 18 is shown provided with an embellisher consisting of a cap 19. The extremity of the windscreen wiper blade 1 is therefore equipped with a cap 19 on which support 21 is clipped. The support 21 has an appropriate length to ensure that it is held on cap 19. A secondary support in the form of an elastic ring 22 provided with an opening 22a, forms one piece with support 21 in one of the lower legs 21a. Conduit 23 is enclosed in the elastic ring 22 in a position parallel to lip 7. Conduit 23 is equipped, at its end, with a ball joint nozzle 24. At the other end, conduit 23 has a connector 23a in which a flexible tube 27 is inserted. Tube 27 joins the arm of the windscreen wiper and passes through a cavity in the arm until it reaches a pump associated with a washer fluid reserve located in the engine compartment of the vehicle. The pump is dimensioned to supply the necessary washer fluid to nozzle 24 for the washing and wiping operation of the glass surface.

FIG. 6 is a view of section B-B of the extremity of a windscreen wiper blade equipped with an end piece, showing the conduit 23 equipped with a nozzle 24. This view clearly shows the position of conduit 23 and nozzle 24 relative to the lip 7. In this view, we see the lip 7 and conduit 23 in a position parallel and juxtaposed over its length to the longitudinal position of lip 7, on which the nozzle 24 is slightly oriented towards lip 7. Conduit 23 has a connector 23a at its extremity opposite nozzle 24 in which tube 27 is inserted.

FIG. 7, which can be considered in connection with wipers positioned identically as those of FIG. 1, shows that on a windscreen, for instance with rounded edges, with the nozzle 24 centered in the cavity or concavity of lip 7 of the windscreen wiper blade 1, the washer fluid jet 25 spreads in the cavity and follows the curvature of the windscreen.

This operation is not possible with the traditional nozzle which projects the washer fluid jet 25 in a straight line as shown in the dot and dash line on FIG. 7, where this jet is projected tangentially to the curvature of the windscreen or the glass surface.

We will now describe a washing and wiping operation of a glass surface 5, with a washing and wiping device equipped with the windscreen wiper blade 1 according to the invention.

When the driver wants to clean his windscreen 5, he actuates the control device provided for this purpose. In a first step, nozzle 24 projects a jet of washer fluid in the concavity of lip 7 of wiper blade 6, the wiper blade being in an inactive position, over the major part of its length, for instance 95 percent. Then in a second step, the wiping is performed, prior to the wiping, lip 7 of wiper blade 6 pivots about articulation hinge 8 and the washer fluid is interposed in the angle formed between the extremity of lip 7 of wiper blade 6 and the glass surface 5 over the whole length of wiper blade 6. In this manner, the washer fluid is distributed evenly along lip 7 of wiper blade 6. Furthermore, during the sweeping movement:

The centrifugal force moves the fluid up to the upper extremity of the wiper blade 6 in order to clean the areas 4a-4b of the windscreen over their whole surface. Another nozzle can be placed on wiper blade 6, in alternating manner relative to nozzle 24, in the lower extremity of wiper blade 6, in order to deliver a washer fluid jet before the blade pivots and the wiper blade returns to its initial position.

The windscreen wiper blade and the washing and wiping method for a glass surface limits in a significant manner the use of washer fluid by delivering just what is necessary, which can lead to a reduction of the volume of washer fluid reservoirs, and consequently a reduction of the overall weight of the vehicle and CO₂ emissions. As a bonus effect, this method improves safety by eliminating the projection of spray which masks the visibility of the driver during the cleaning of the windscreen or during night driving.

It is understood that the invention is not limited to the one embodiment described and shown with reference to the attached drawings; on the contrary the invention encompasses all variants. For instance, the nozzle can be mounted on any type of wiper blade and the glass surface can alternatively be a rear window of a vehicle or the lens of a headlight.

It is also understood that the washer fluid jet can be projected in the concavity of the lip of the wiper blade over the totality of the length of the wiper blade.

1. A windscreen wiper assembly of an automotive vehicle, comprising
an elongated flexible wiper blade having a lip;
a conduit having a conduit exit, the conduit exit being positioned relative to the wiper blade to direct a fluid jet in the longitudinal direction of the wiper blade;
wherein the conduit exit is offset on the side of the flexible wiper blade relative to the median longitudinal plane of the flexible wiper blade, the wiper blade supporting said conduit, said conduit exit comprising a nozzle, said conduit being offset laterally relative to the longitudinal median axis of the wiper blade at a distance such that when the windscreen wiper blade assembly is in an inactive position on the glass surface, the nozzle is direct toward a concave part of the lip of wiper blade, so that a washer fluid jet can spread over the major part of the length of lip of wiper blade.

2. The windscreen wiper assembly of an automotive vehicle according to claim 1, wherein the exit of the conduit is disposed at an extremity of the wiper blade.

3. The windscreen wiper assembly of an automotive vehicle according to claim 2, wherein the exit of the conduit is disposed along the wiper blade.

4. The windscreen wiper assembly of an automotive vehicle according to claim 1, wherein the exit of the conduit comprises a nozzle.

5. The windscreen wiper assembly according to claim 4, wherein the axis of the nozzle is disposed parallel to the lip of the wiper blade so as to direct the washer fluid in the concavity of lip of wiper blade when the wiper blade is in its stop position, prior to returning.

6. The windscreen wiper assembly according to claim 4, wherein the axis of the nozzle is oriented in direction of the lip of the wiper blade so as to direct the washer fluid to lip of wiper blade when the latter is in its stop position, prior to returning in order to perform the wiping of the glass surface.

7. The windscreen wiper assembly according to claim 1, wherein the conduit of the nozzle is disposed in a holding means suitable to hold it in a specific position relative to the lip of the wiper blade.

8. The windscreen wiper (1) assembly according to claim 7, wherein the holding means comprises an elastic ring part of a support which is clipped in an appropriate manner on the extremity of the windscreen wiper blade.

9. The windscreen wiper (1) assembly according to claim 1, wherein the conduit of nozzle comprises, in its extremity opposite the nozzle, a connector for a tube intended for carrying washer fluid from a storage reservoir in direction of conduit and nozzle.

10. The windscreen wiper blade assembly according to claim 1, wherein the conduit delivers a constant flow.

11. A windscreen wiper arm carrying a windscreen wiper blade according to claim 1, that wherein the exit of the conduit is disposed in the extremity of the wiper blade which is situated on the side of the fixation of the arm.

12. A washing and wiping device comprising at least one windscreen wiper blade for a glass surface according to claim 1.

13. An automotive vehicle comprising at least one washing and wiping device for a glass surface (5) according to claim 12.

14. A method for washing and wiping a glass surface comprising at least one windscreen wiper assembly, the windscreen wiper assembly comprising a flexible elongated wiper blade resting on the glass surface to be swept over the glass surface, whereby the flexible wiper blade is supporting a conduit having an exit, the conduit being offset on a side of the flexible wiper blade at a distance such that when the windscreen wiper assembly is at an end of travel position on the glass surface, the exit of the conduit is positioned opposite a concave part of a lip of the wiper blade, the method comprising:
prior to activating the wiper blade, a step in which a washer fluid jet flows over the majority of the concave portion of lip of the wiper blade through the disposed exit of the conduit,
when the wiper blade (6) start to move, a step in which the lip returns and during which the washer fluid spreads over the portion of the lip in contact with the glass surface in order to carry out the washing of the glass area to be cleaned.

15. The method for washing and wiping a glass surface according to claim 14, wherein the washer jet is adjusted to flow over the length of the lip of wiper blade over at least three quarters of its length.

16. The method for washing and wiping a glass surface according to claim 14, wherein the washer fluid spreads from the nozzle disposed in a first extremity of the lip of wiper blade, until a second extremity of the lip of the wiper blade under the effect of the centrifugal force when wiper blade is in movement, while in its movement the second extremity describes a larger radius than the first extremity.

17. The method for washing and wiping of a glass surface according to claim 14, wherein during a stop of the wiper blade in its vertical position at the end of travel of the area to be wiped, and before returning, a jet of washer fluid is spread over the length of the lip of the wiper blade by the nozzle disposed in the extremity of the wiper blade describing a larger radius than the other extremity.

18. (canceled)
